(19) United States
(12) Patent Application Publication
(10) Pub. No.: US 2016/0313248 A1
(43) Pub. Date: Oct. 27, 2016

(54) OPTICAL ANALYZER

(71) Applicant: SHIMADZU CORPORATION, Kyoto-shi (JP)

(72) Inventors: Yusuke NAGAI, Kyoto-shi (JP); Keisuke OGAWA, Kyoto-shi (JP); Masato WATANABE, Kyoto-shi (JP); Kumiko JINGU, Kyoto-shi (JP); Masanori FUJIWARA, Kyoto-shi (JP); Tomoyuki YAMAZAKI, Kyoto-shi (JP)

(73) Assignee: SHIMADZU CORPORATION, Kyoto-shi (JP)

(21) Appl. No.: 15/135,626

(22) Filed: Apr. 22, 2016

(30) Foreign Application Priority Data
Apr. 24, 2015 (JP) 2015-089287

(51) Int. Cl. G01N 21/64; G01N 21/25; G01N 21/31

(52) U.S. Cl. CPC G01N 21/645; G01N 21/31; G01N 21/255; G01N 2201/06153

(57) ABSTRACT

Light emitted from a light casting unit 1 including an LED as its light source is cast into a sample cell 2, and a photodetector 3 is placed at a position where the resultant passing light can be detected. The LED is driven to blink, and a data extracting section 71 extracts data obtained in a period in which the LED is turned on, as data (absorbance data) in which absorption of light by the sample solution is reflected. Moreover, in the case where a fluorescent component is contained in the sample solution, fluorescent light is emitted by the cast light serving as excitation light. Even after the excitation light ceases, the emission of the fluorescent light continues for a short time, and hence the data extracting section 71 extracts data obtained immediately after the LED is turned off, as data (fluorescence data) in which the fluorescent light is reflected. An absorbance computing section 72 calculates absorbance based on the absorbance data, and a fluorescence computing section 73 calculates fluorescence intensity based on the fluorescence data. Accordingly, it is possible to simultaneously perform an absorbance measurement and a fluorescence measurement on one sample while using one photodetector and thus simplifying the configuration of an optical system.

### TECHNICAL FIELD

The present invention relates to an optical analyzer for performing an absorbance measurement and a fluorescence measurement on a sample in parallel.

### BACKGROUND ART

In order to detect components in a liquid sample that has been separated by a liquid chromatograph (LC), an absorbance measurement using an ultraviolet-visible spectrophotometer, a photodiode array (PDA) detector, or the like is often performed. Moreover, with regard to fluorescent components and fluorescently labelable components, a fluorescence measurement using a fluorescence spectrophotometer is performed in some cases. Although components for which the fluorescence measurement is possible are limited, in general, the sensitivity of the fluorescence measurement is far higher than that of the absorbance measurement. Hence, particularly in the fields involving a strong need for a microanalysis, such as life science, drug development, and environment measurement, there is a strong demand to perform the absorbance measurement and the fluorescence measurement on the same sample in parallel.

In order to perform the absorbance measurement and the fluorescence measurement in parallel on a liquid sample that has been separated by a LC, such a configuration is generally adopted that an absorbance detector and a fluorescence detector, both composed of PDA detectors, for example, are connected in series or in parallel to a column outlet of the LC. In the configuration of the absorbance detector and the fluorescence detector connected in series, the liquid sample that has passed through the front-stage detector is introduced to the rear-stage detector through a pipe. Hence, diffusion of components in the sample in the time direction are larger in the rear-stage detector than in the front-stage detector. This leads to the problems of, for example, an expanded peak width and a decreased height of a peak top of a chromatogram. Meanwhile, in the configuration of the absorbance detector and the fluorescence detector connected in parallel, it is necessary to divide the liquid sample eluted from the column outlet of the LC in two and respectively introduce the divided liquid samples to the two detectors. This causes problems in that the two detectors do not measure the same liquid sample (that is, the concentration of the components in the target liquid sample may be slightly different) and that the signal intensity decreases.

In order to avoid the above-mentioned problems, an apparatus capable of performing both the absorbance measurement and the fluorescence measurement on a liquid sample contained in a cell has been developed. For example, an apparatus described in Non Patent Literature 1 includes two photodetectors of: a photodetector for absorbance measurement that detects light that has passed through a sample; and a photodetector for fluorescence measurement that detects fluorescent light emitted from the sample, the fluorescence photodetector being placed at a position at which the passing light does not enter the photodetector, and this apparatus can simultaneously measure an absorbance spectrum and a fluorescence spectrum. Patent Literature 1 also describes that the fluorescence measurement and the absorbance measurement can be simultaneously performed according to a configuration similar to that of Non Patent Literature 1. However, according to such a configuration, a plurality of photodetectors are necessary, and the configuration of the optical system is complicated, resulting in high cost.

Patent Literature 2 describes an apparatus including: a shutter mechanism provided between a sample and one photodetector; and a light guide for guiding light that is emitted from the sample in a direction orthogonal to incident light, to the photodetector. When the absorbance measurement is performed, the shutter is opened, and light that has passed through the sample reaches the photodetector. When the fluorescence measurement is performed, the shutter is closed, and fluorescent light that has passed through the light guide reaches the photodetector. In this way, this apparatus can perform both the absorbance measurement and the fluorescence measurement. According to this configuration, though not exactly simultaneously, the optical paths are switched by the shutter at high speed, whereby the absorbance measurement and the fluorescence measurement on the same sample can be substantially simultaneously performed. However, even according to such a configuration, the configuration of the optical system, the shutter mechanism, and the like are complicated.

### CITATION LIST

### Patent Literature

[Patent Literature 1] JP 2005-147826 A (paragraph [0051], FIG. 5)

[Patent Literature 2] JP 2006-503267 A (paragraphs [0025] to [0027], FIG. 2)

### Non Patent Literature

[Non Patent Literature 1] Susumu YAMAUCHI, “Environmental Technology Introduction: Evaluations on Chromophoric Dissolved Organic Matters using Three-dimensional Fluorescence Measurement Apparatus”, “KANGIKYO” Magazine, Japan Environmental Technology Association, July, 2014, p. 18-19

### SUMMARY OF INVENTION

### Technical Problem

An object of the present invention, which has been made in order to solve the above-mentioned problems, is to provide a low-cost, small-size optical analyzer capable of performing an absorbance measurement and a fluorescence measurement substantially simultaneously on the same sample while using the same photodetector and thus simplifying an optical system.

### Solution to Problem

In order to achieve the above-mentioned object, an optical analyzer according to the present invention includes:

a) a light casting unit for casting light into or onto a target sample, the light casting unit including a light-emitting semiconductor device as a light source;

b) a light detecting unit placed at a position where light that has passed through the sample can be detected, the detected light being of the light that is cast into or onto the sample from the light casting unit;

c) a light source driving unit for driving the light source to blink; and

d) a signal processing unit for processing a detection signal that is obtained by the light detecting unit in at least part of a period in which the light source driving unit drives the light source to turn on as a signal in which absorption by the sample is reflected, and for processing a detection signal that is obtained by the light detecting unit in at least part of a period in which the light source driving unit drives the light source to turn off as a signal in which fluorescent light from the sample is reflected.

In the optical analyzer according to the present invention, the light-emitting semiconductor device is used as the light source instead of conventionally used deuterium lamp or xenon flash lamp. Examples of the light-emitting semiconductor device here include light emitting diodes (LED), super luminescence diodes (SLD), and laser diodes (LD). The peak width of the emission spectrum of the light-emitting semiconductor device is generally small, and hence light emitted from the light-emitting semiconductor device can be directly used as measurement light without being transformed into monochromatic light by an expensive spectroscope or monochromator.

The light-emitting semiconductor device directly converts supplied electrical energy into optical energy to emit light, and hence rising and falling of the light emission extremely rapidly follow turning on/off of a drive current. Hence, a high-speed on/off operation, that is, microsecond order repetition of turn on/off operation is possible. Accordingly, in the optical analyzer according to the present invention, the light source driving unit drives the light source to blink at a predetermined frequency. When the light source is turned on, the light emitted from the light source is cast as measurement light into or onto the sample, and is absorbed by the sample while passing through the sample. Then, the light that has undergone absorption while passing reaches the light detecting unit. Accordingly, the signal processing unit performs predetermined processing on the detection signal that is obtained by the light detecting unit in at least part of the period in which the light source is driven to be turned on, as the signal in which the absorption by the sample is reflected, and thus calculates, for example, the absorbance of the sample.

In the case where the sample contains a fluorescent component and where the wavelength of the light cast from the light source includes a wavelength effective as excitation light, the fluorescent light is emitted in various directions from the sample that has received the cast light. Even after the light source is turned off and the excitation light ceases, the emission of the fluorescent light from the sample continues for a certain amount of time, although it is a short time. Accordingly, the signal processing unit performs predetermined processing on the detection signal that is obtained by the light detecting unit in the period immediately after the light source is turned off, as the signal in which the fluorescent light from the sample is reflected, and thus calculates, for example, the intensity of the fluorescent light from the sample.

Although the detection signal obtained when the light source is turned on may contain components of the fluorescent light emitted from the sample, normally, the intensity of the fluorescent light is substantially lower than the intensity of the passing light, and hence the fluorescent light included in it do not cause any problem at the time of calculating the absorbance.

Because the emission wavelength band of the light-emitting semiconductor device is narrow, it is normally not necessary to provide an optical element such as a filter for limiting the wavelength band on an optical path between the light casting unit and the sample, but an optical filter may be placed as needed to limit the wavelength band of the cast light. Similarly, an appropriate optical filter or polarization element may be placed on an optical path between the sample and the light detecting unit.

The wavelength of excitation light for exciting a fluorescently labeled component is different depending on the type of fluorescent substance and other factors. Hence, in order to detect various components respectively fluorescently labeled with a plurality of different fluorescent substances, excitation lights having different wavelengths may need to be cast into or onto the sample, but the plurality of wavelengths may not be covered by one light-emitting semiconductor device.

In such a case, in the optical analyzer according to the present invention, the light casting unit may include a plurality of light-emitting semiconductor devices having different emission wavelengths as the light sources, and the light source driving unit may drive the plurality of light sources to simultaneously blink or may drive one of the plurality of light sources to selectively blink.

According to this configuration, excitation lights having different wavelengths are simultaneously or selectively cast into or onto the sample, and fluorescent lights emitted from the sample are detected by the light detecting unit immediately after the excitation lights cease, whereby fluorescent lights from components respectively fluorescently labeled with different fluorescent substances can be detected altogether.

### Advantageous Effects of Invention

An optical analyzer according to the present invention makes it possible to perform an absorbance measurement and a fluorescence measurement substantially simultaneously on a sample housed in one sample container with the use of one light detecting unit and without the use of special optical components and optical elements such as a light guide. Accordingly, simultaneous measurements of absorbance and fluorescent light can be performed using a low-cost, small-size apparatus.

### BRIEF DESCRIPTION OF DRAWINGS

FIG. 1 is a schematic configuration diagram of an absorbance/fluorescence detector according to an embodiment of the present invention;

FIG. 2A, FIG. 2B, and FIG. 2C are operation timing charts in the absorbance/fluorescence detector of the present embodiment;

FIG. 3 is a schematic configuration diagram of an optical measurement unit of an absorbance/fluorescence detector according to another embodiment of the present invention; and

FIG. 4 is a schematic configuration diagram of an absorbance/fluorescence detector according to another embodiment of the present invention.

### DESCRIPTION OF EMBODIMENTS

Hereinafter, an absorbance/fluorescence detector according to an embodiment of the present invention is described with reference to the attached drawings.

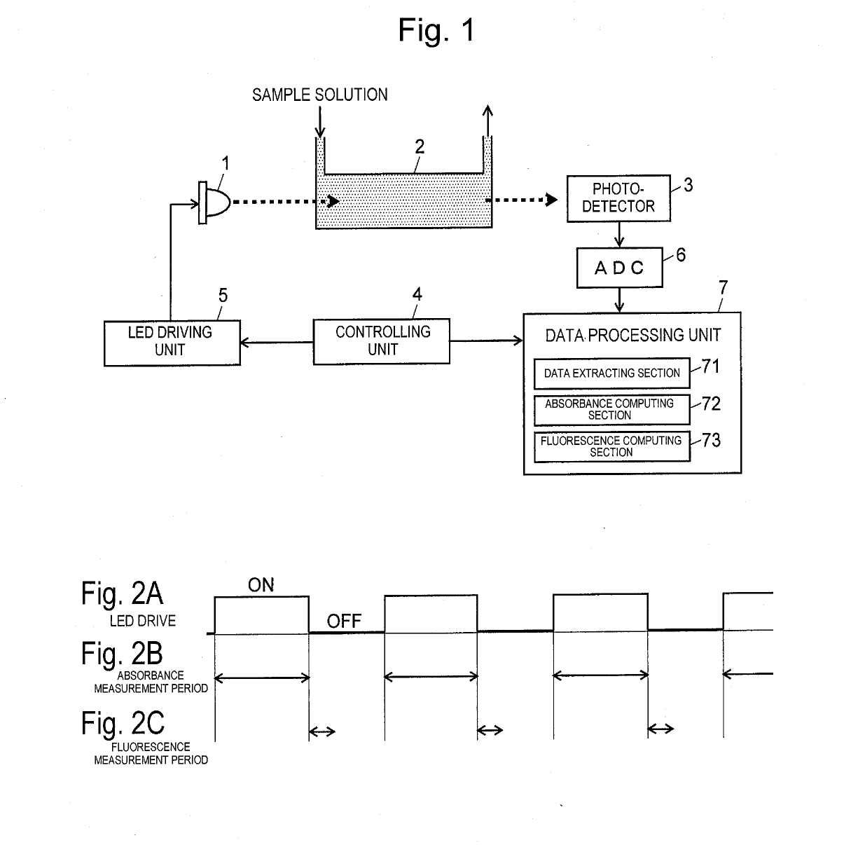

FIG. 1 is a schematic configuration diagram of the absorbance/fluorescence detector of the present embodiment, and FIG. 2A, FIG. 2B, and FIG. 2C are operation timing charts in the absorbance/fluorescence detector of the present embodiment. A sample cell 2 in which a target sample solution flows is connected to, for example, an outlet of a column of a LC, and the sample solution containing various components temporally separated in the column flows in the sample cell 2 at a substantially constant flow rate.

In FIG. 1, a light casting unit 1 including a single LED as its light source is driven by a drive current supplied from an LED driving unit 5 to emit light. The light emitted from the light casting unit 1 is cast as measurement light and excitation light into the sample cell 2. Light that has passed through the sample cell 2, of the measurement light, and fluorescent light that is emitted from the sample solution in the sample cell 2 by the excitation light reach a photodetector 3. The element type of the photodetector 3 need not be limited as long as the photodetector 3 has sensitivity for the emission wavelength of the light casting unit 1 and the wavelength of the fluorescent light emitted from the sample. Moreover, the LED included in the light casting unit 1 may exhibit an emission spectrum including the wavelength of excitation light for a fluorescent component (or a fluorescent substance used for fluorescent labeling) in the target sample solution.

After the passing light and the fluorescent light enter the photodetector 3, the photodetector 3 generates a detection signal. The detection signal is converted into digital data by an analog-digital converter (ADC) 6 at predetermined sampling intervals, and the digital data is input to a data processing unit 7. The data processing unit 7 includes functional blocks such as a data extracting section 71, an absorbance computing section 72, and a fluorescence computing section 73. A controlling unit 4 controls the LED driving unit 5 and sends a timing control signal to the data processing unit 7 in order to perform simultaneous measurements of absorbance and fluorescence to be described later.

Although the controlling unit 4 and the data processing unit 7 can be configured using a hardware circuit including a microcomputer, in general, the entirety or a part of the functions of the controlling unit 4 and the data processing unit 7 can be achieved by executing, on a general-purpose computer, dedicated software for control and processing installed on the computer.

Next, an example typical operation of the absorbance/fluorescence detector of the present embodiment is described.

The controlling unit 4 sends such a rectangular-wave control signal illustrated in FIG. 2A to the LED driving unit 5 and the data processing unit 7. The frequency of the rectangular-wave control signal may be set to, for example, approximately several hertz to several kilohertz. The LED driving unit 5 supplies a predetermined drive current to the light casting unit 1 when the control signal is in the H level, and stops the supply of the drive current when the control signal is in the L level. The LED driving unit 5 includes a constant current circuit, and the current value of the drive current is always kept constant. Because the LED is turned on/off at high speed in the light casting unit 1, the LED is turned on when the control signal is in the H level, and the LED is turned off when the control signal is in the L level. That is, the LED included in the light casting unit 1 blinks in the cycle of the rectangular-wave control signal.

When the LED is turned on, the light emitted from the light casting unit 1 is cast into the sample cell 2, and passes through the sample cell 2. In that process, part of the light is absorbed by the sample solution in the sample cell 2, and hence a decreased amount of light reaches the photodetector 3. The photodetector 3 outputs a detection signal according to the intensity (amount) of incident light, and hence a detection signal that is output from the photodetector 3 when the control signal is in the H level is a signal in which the degree of the absorption by the sample solution in the sample cell 2 is reflected. In the case where a fluorescent component is contained in the sample solution, the component receives the light to emit fluorescent light. Because the fluorescent light is emitted in every direction, part of the fluorescent light reaches the photodetector 3, but influences of this fluorescent light cause almost no problem because the intensity of the fluorescent light is normally lower than the intensity of the passing light.

When the on-state LED is turned off, the light passing through the sample solution, of the measurement light, naturally ceases, but the fluorescent light that is emitted from the fluorescent component in the sample solution by the light that is cast to the sample solution immediately before the turning off and serves as excitation light continues to be emitted for a while, although it is a short time (normally, approximately subnanosecond to 100 nanoseconds), even after the excitation light ceases. Hence, a detection signal that is output from the photodetector 3 in a predetermined time immediately after the control signal changes from the H level to the L level is a signal in which only the fluorescent light emitted from the fluorescent component in the sample solution is reflected.

In view of the above, in the data processing unit 7, the data extracting section 71 extracts, from time-series continuous data, data in which the absorption of light by the sample solution is reflected and data in which only the fluorescent light from the sample solution is reflected, based on the control signal given from the controlling unit 4. Specifically, as illustrated in FIG. 2B, the data extracting section 71 extracts data obtained in a period in which the control signal is in the H level, as the data (absorbance data) in which the absorption of light by the sample solution is reflected. Meanwhile, as illustrated in FIG. 2C, the data extracting section 71 extracts data obtained in a predetermined period immediately after the control signal changes from the H level to the L level, as the data (fluorescence data) in which the fluorescent light is reflected. As a result, the absorbance data and the fluorescence data on substantially the same sample solution can be acquired from data obtained by digitizing the detection signals obtained by one photodetector 3.

In order to avoid the trouble that long-life fluorescent light generated in a fluorescence measurement is erroneously detected as passing light in the subsequent absorbance measurement, a non-detection period in which data is not detected may be provided one or both of before and after the control signal is switched between the H level and the L level.

The absorbance computing section 72 receives the absorbance data, and calculates the absorbance of the sample solution according to a known algorithm similar to a conventional one. Meanwhile, the fluorescence computing section 73 receives the fluorescence data, and calculates the intensity value of the fluorescent light emitted from the fluorescent component in the sample solution. The flow of the sample solution in the sample cell 2 is much slower than the blinking cycle of the LED in the light casting unit 1. Accordingly, in a period in which the LED is turned on/off several times, the sample solution in the sample cell 2 can be regarded as the same (that is, the components in the sample solution can be regarded as unchanged). Considering this, the absorbance computing section 72 and the fluorescence computing section 73 may respectively accumulate pieces of absorbance data and pieces of fluorescence data obtained based on a large number of temporally continuous blinks of the LED, and thus calculate the absorbance and the fluorescence intensity. This can enhance the calculation accuracy and the sensitivity of the absorbance and the fluorescence intensity.

In such a manner as described above, the absorbance/fluorescence detector of the present embodiment can perform an absorbance measurement and a fluorescence measurement substantially simultaneously on one sample while using one photodetector and thus simplifying the configuration of the optical system. Accordingly, for example, the absorbance and the fluorescence intensity can be obtained for various components separated by the LC, using the low-cost, small-size detector.

Because the life of the fluorescent light also depends on the kind of fluorescent substance, it goes without saying that, in the case of labeling a target component with a fluorescent substance, it is more advantageous to use a substance having long life fluorescent light.

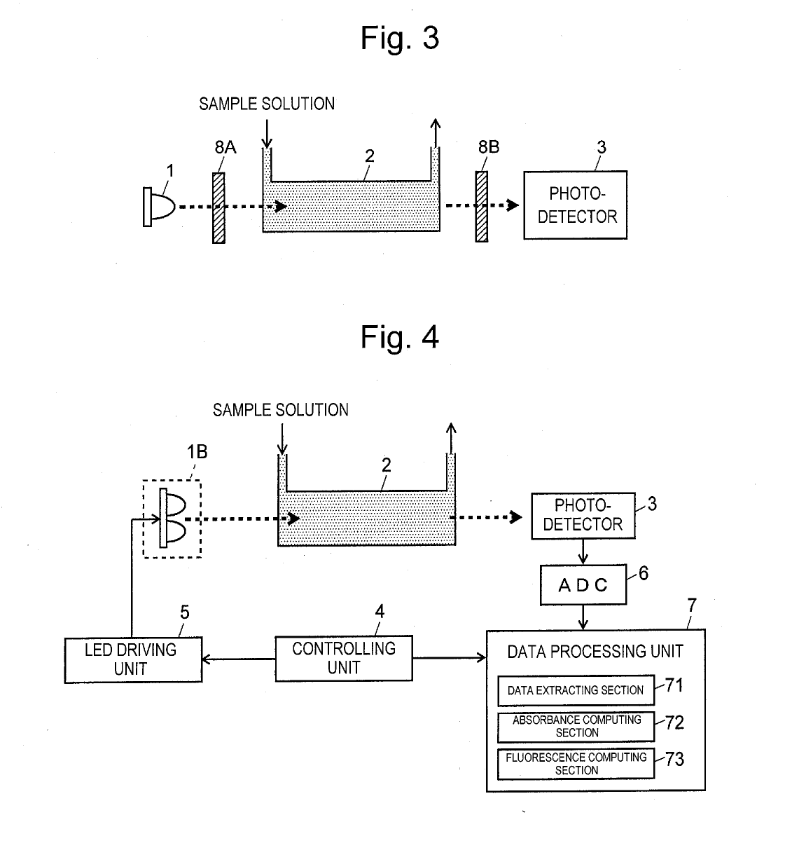

In the above-mentioned embodiment, the light emitted from the light casting unit 1 is directly cast into the sample cell 2, and the light that has passed through the sample cell 2 and the light emitted from the sample cell 2 are directly introduced to the photodetector 3. Alternatively, another optical element such as an optical filter having predetermined transmission characteristics may be provided on any one or both of an optical path between the light casting unit 1 and the sample cell 2 and an optical path between the sample cell 2 and the photodetector 3. FIG. 3 is an optical path configuration diagram of an absorbance/fluorescence detector in the case where optical filters 8A and 8B are respectively provided on the two optical paths.

The optical filter 8A having a transmission characteristic capable of selecting a wavelength λ₁ effective as excitation light is provided on the optical path between the light casting unit 1 and the sample cell 2. Moreover, the optical filter 8B having a transmission characteristic capable of selecting the wavelength λ₁ effective as excitation light and a wavelength λ₂ of the fluorescent light that is excited by the excitation light and emitted from a sample component is provided on the optical path between the sample cell 2 and the photodetector 3. Although the peak width of the emission spectrum of the LED is generally narrow, light having a wavelength other than a wavelength used for measurement may become noise to cause a decrease in measurement accuracy. To solve this, according to the configuration illustrated in FIG. 3, light having a wavelength unnecessary for measurement is prevented from entering the photodetector 3, so that the measurement accuracy can be enhanced.

In the above-mentioned embodiment, light having a given particular wavelength is used as measurement light and excitation light, but lights having a plurality of wavelengths may need to be used as excitation lights in the case where a sample containing a plurality of components having different fluorescence characteristics or labeled with different fluorescent substances is separated by the LC and is detected.

In such a case, as illustrated in FIG. 4, a plurality of LEDs having different emission spectra may be used for a light casting unit 1B, and the controlling unit 4 may control the LED driving unit 5 to simultaneously cause the plurality of LEDs to be turned on/off, or may control the LED driving unit 5 to selectively cause one of the plurality of LEDs to be turned on/off. In the case of selectively causing the LEDs to be turned on/off, a time-division operation may be performed for repetitively causing the plurality of LEDs to be turned on/off in order.

In the case of selectively blinking the plurality of LEDs, for example, an LED to be driven to blink may be switched in accordance with the retention time of a target component in the LC, but absorbance comparison is difficult if the LEDs have different emission wavelengths. Accordingly, for example, a difference in absorbance of the same component depending on the different emission wavelengths of the LEDs may be examined in advance, and absorbance measurement results obtained using the different LEDs may be calibrated to be comparable, based on the examined difference.

Although omitted from the illustrations in FIG. 1, FIG. 3, and FIG. 4, the amount of light emitted from an LED is generally temperature dependent. To reduce the influence of temperature, it is desirable to perform a temperature control for maintaining the LED at a substantially constant temperature in the light casting unit 1 or 1B or perform a feedback control in which part of the light emitted from the LED is monitored and a drive current to the LED is controlled such that the monitored light is maintained at a substantially constant amount. In the case where the absorbance/fluorescence detector of the present embodiment is used as a detector for the LC, the present detector is placed inside of a column oven used for maintaining a column at a substantially constant temperature, whereby the temperature of the light casting unit 1 or 1B can also be regulated by the column oven.

Although an LED is used as the light source in each of the above-mentioned embodiments, an optical analyzer using a light-emitting semiconductor device other than the LED, such as a super luminescence diode (SLD) or a laser diode (LD), as its light source can also be configured in a similar fashion.

It should be noted that the above-mentioned embodiments and their variations are mere examples of the present invention and will naturally fall within the scope of claims of the present application even if a change, modification, or addition is appropriately made within the gist of the present invention.

### REFERENCE SIGNS LIST

1, 1B . . . Light Casting Unit
2 . . . Sample Cell
3 . . . Photodetector
4 . . . Controlling Unit
5 . . . LED Driving Unit
7 . . . Data Processing Unit
71 . . . Data Extracting Section
72 . . . Absorbance Computing Section
73 . . . Fluorescence Computing Section
8A, 8B . . . Optical Filter

1. An optical analyzer comprising:
a) a light casting unit for casting light into or onto a target sample, the light casting unit including a light-emitting semiconductor device as a light source;
b) a light detecting unit placed at a position where light that has passed through the sample can be detected, the detected light being of the light that is cast into or onto the sample from the light casting unit;
c) a light source driving unit for driving the light source to blink; and
d) a signal processing unit for processing a detection signal that is obtained by the light detecting unit in at least part of a period in which the light source driving unit drives the light source to turn on as a signal in which absorption by the sample is reflected, and for processing a detection signal that is obtained by the light detecting unit in at least part of a period in which the light source driving unit drives the light source to turn off as a signal in which fluorescent light from the sample is reflected.

2. The optical analyzer according to claim 1, wherein
the light casting unit includes a plurality of light-emitting semiconductor devices having different emission wavelengths as the light sources, and
the light source driving unit drives the plurality of light sources to simultaneously blink or drives one of the plurality of light sources to selectively blink.
